(19) United States
(12) Patent Application Publication
(10) Pub. No.: US 2007/0132578 A1
(43) Pub. Date: Jun. 14, 2007

(54) MONITORING SYSTEM AND METHOD

(76) Inventor: Michael John Powell, Canning Vale (AU)

Correspondence Address: GARDNER GROFF SANTOS & GREENWALD, P.C., 2018 POWERS FERRY ROAD, SUITE 800, ATLANTA, GA, 30339, US

(21) Appl. No.: 11/610,213

(22) Filed: Dec. 13, 2006

(30) Foreign Application Priority Data
Dec. 14, 2005 (AU) 2005907021

(51) Int. Cl. G08B 1/08; G08B 23/00

(52) U.S. Cl. 340/539.26; 340/539.22; 340/527

(57) ABSTRACT

A monitoring system (10) for monitoring people in swimming pools and other similar environments has a child unit (12) and a parent unit (14) that are in wireless communication with each other. The child unit is intended to be worn by a person near a swimming pool. The child unit includes a water sensor and a proximity sensor that detect when the child unit is immersed in water or when it is removed from the person—potentially hazardous environments. The child unit sends signals to the parent unit indicative of the state of the environment. If the state of the environment is detected as being hazardous, then the parent unit is operable to emit an alarm. The emission of the alarm is delayed by a predetermined time delay, which is variable depending upon the needs of the person being monitored.

### CROSS-REFERENCE TO RELATED APPLICATION

This application claims the priority benefit of Australian Provisional Patent Application Serial No. 2005907021, filed Dec. 14, 2005, the entire scope and content of which is hereby incorporated herein by reference.

### FIELD OF THE INVENTION

The present invention relates to a monitoring system and method.

The system and method are particularly relevant to monitoring a person having little or no swimming ability, such as a young child, when playing in or near water, such as at a beach or a swimming pool. However, the invention is applicable to monitoring any person or animal in a potentially hazardous environment from which they may require rescue or assistance.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND OF THE INVENTION

The following discussion of the background to the invention is intended to facilitate an understanding of the present invention. However, it should be appreciated that the discussion is not an acknowledgment or admission that any of the material referred to was published, known or part of the common general knowledge of the person skilled in the art in any jurisdiction as at the priority date of the invention.

People having little or no swimming ability, such as young children, are susceptible to drowning if they enter water. For this reason, an adult will typically endeavour to supervise young children when playing in or near water to ensure that they are able to rescue them if they require assistance. This can be very difficult and stressful however, particularly if there is a number of children who must be supervised, and the environment is chaotic, for example with children running around, jumping into the water, diving, splashing, yelling and screaming, and generally having a good time.

Systems and methods have been disclosed to facilitate the monitoring of a person in or near water. However, these systems and methods may suffer from one or more of the following problems:
unsuitable for use in situations where the person is allowed in the water, but needs to be monitored in the event that they require assistance;
not adaptable to take into account age, swimming ability, fatigue, or play of the monitored person;
unsuitable for use in particular water types, such as salt water;
unable to monitor multiple people simultaneously;
unable to facilitate flexible control of the freedom provided to the monitored person;
base units of the system are not very portable, being either bulky, or being required to be located near the water;
do not use a fail-safe method of triggering an alarm in an emergency situation;
do not use a 2-way communications link, thereby limiting system reliability;
do not use techniques to maximise immunity to interference, such as Direct Sequence Spread Spectrum modulation;
do not monitor the quality of the radio link such that, in the event of excessive interference, a new frequency channel can be selected; and
do not allow the alarm to distinguish between out-of-range and immersion in water.

The present invention seeks to provide a monitoring system and method that alleviates some or all of these problems to at least some extent.

### SUMMARY OF THE INVENTION

In accordance with a first aspect of the present invention, there is provided a monitoring system comprising a first module and a second module, the first module comprising:

a sensor operable to sense the state of an environment in which the first module is located; and

a first communications device coupled to the sensor and operable to transmit a first signal to the second module indicative of the sensed environment and in response to the sensed state of the environment;

the second module comprising:

a second communications device operable to receive the first signal from the first module;

an alerting device coupled to the second communications device and operable to generate an alert in response to a change in condition of the state of the sensed environment;

a variable timer coupled to the alerting device and operable to delay generation of the alert by the alerting device for a variable predetermined time delay period; and

a controller operable to set the length of the variable predetermined time delay period in response to user input.

Preferably, the first signal from the first module is indicative of a non-hazardous state of the environment, and a change to a hazardous state of the environment is indicated by the non-receipt of the first signal by the second communications device and the generation of an alert by the alerting device is in response to the non-receipt of the first signal from the first module.

Alternatively, the first signal from the first module is indicative of a hazardous state of the environment, and a change to a hazardous state of the environment is indicated by the receipt of the first signal by the second communications device and the generation of an alert by the alerting device is in response to the receipt of the first signal from the first module.

Preferably, the timer is operable, in response to a detected change of the environment to a hazardous state, to count down the set variable predetermined time delay period and, upon expiration of the count down, the alerting device is operable to generate the alert.

Preferably, the first communications device is operable, in response to a detected change of the environment from a hazardous state to a non-hazardous state, to transmit a second signal to the second module, the second communications device is operable to receive the second signal from the first module, and the timer is operable, in response to receipt of the second signal, to abort the delay and reset to the set variable predetermined time delay period, and upon abortion of the delay, the alerting device is operable to not generate the alert.

Preferably, the timer is operable, in response to a detected change of the environment to a hazardous state, to count down the set variable predetermined time delay period and, wherein the first communications device is operable, in response to a detected change of the environment from a hazardous state to a non-hazardous state, to transmit a second signal to the second module, the second communications device being operable to receive the second signal from the first module, and the timer being operable, in response to receipt of the second signal, to abort the delay and reset to the set variable predetermined time delay period, and upon abortion of the delay, the alerting device is operable to not generate the alert.

Preferably, the timer is further operable, in response to receipt of the second signal, to abort the count down and to reset to the set variable predetermined time delay period, and upon abortion of the count down, the alerting device is operable to not generate the alert.

Preferably, the timer is operable, in response to receipt of the second signal, to abort the delay and to reset to a shortened predetermined time delay period, less than the set variable predetermined time delay period.

Preferably, the timer is operable to count down the set variable predetermined time delay period, and the timer is further operable, in response to receipt of the second signal, to abort the count down, and start counting up in predetermined increments until the value of the set variable predetermined time delay period is reached.

If there is a detected change in the environment to a hazardous state again, before the timer has counted up to the value of the set variable predetermined time delay period, then the timer is preferably operable to shorten the delay to less than the set variable predetermined time delay period.

Preferably, the length of the set variable predetermined time delay period is proportional to the age and/or swimming ability of a person to be monitored via the monitoring system.

Preferably, the first communications device and/or the second communications device comprise a transceiver and an antenna for wireless communication therebetween.

Preferably, the second and/or first communications device comprises a signal strength detector for detecting the strength of the signal from the first and/or second communications device respectively, and is operable to determine when the signal strength drops below a predetermined level, the alerting device being further operable, in response to a determined signal strength below the predetermined level, to generate an alert.

Preferably, the sensor comprises at least one of the following set: water sensor; body proximity sensor; heart rate sensor; pressure sensor; motion sensor; gas sensor; infrared sensor; and light sensor.

Preferably, the first module and/or the second module are waterproof.

Preferably, the first module and/or the second module are provided with an attachment device for removable attachment to a person.

Preferably, the attachment device is provided with a removal preventer to prevent accidental removal of the first module and/or the second module from a person.

In accordance with a second aspect of the present invention, there is provided a monitoring method comprising:

sensing the state of an environment;

transmitting a first signal indicative of the sensed environment in response to the sensed state of the environment;

receiving the first signal;

generating an alert in response to a change in condition of the state of the sensed environment; and

delaying generation of the alert for a variable predetermined time delay period, the length of the variable predetermined time delay being set by a user to define a set variable predetermined time delay.

Preferably, the first signal is indicative of a non-hazardous state of the environment, and a change to a hazardous state of the environment is indicated by the non-receipt of the first signal and the generation of the alert is in response to the non-receipt of the first signal.

Alternatively, the first signal is indicative of a hazardous state of the environment, and a change to a hazardous state of the environment is indicated by the receipt of the first signal and the generation of the alert is in response to the receipt of the first signal.

Preferably, the method further comprises counting down the set variable predetermined time delay period in response to a detected change of the environment to a hazardous state, and upon expiration of the count down, generating the alert.

Preferably, the method further comprises transmitting a second signal in response to a detected change of the environment from a hazardous state to a non-hazardous state, receiving the second signal, and, in response to receiving the second signal, aborting the delay, resetting the set variable predetermined time delay period, and not generating the alert.

Preferably, the method further comprises counting down the set variable predetermined time delay period in response to a detected change of the environment to a hazardous state; and transmitting a second signal in response to a detected change of the environment from a hazardous state to a non-hazardous state, receiving the second signal, and, in response to receiving the second signal, aborting the delay, resetting the set variable predetermined time delay period, and not generating the alert.

Preferably, the method comprises aborting the count down, resetting the set variable predetermined time delay period, and not generating the alert in response to receiving the second signal.

Preferably, the method further comprises resetting the delay to a shortened predetermined time delay period, less than the set variable predetermined time delay period, in response to receiving the second signal.

Preferably, the method further comprises counting up in predetermined increments, in response to receiving the second signal, until either the value of the set variable predetermined time delay period is reached, or there is a detected change in the environment to a hazardous state.

Preferably, the set variable predetermined time delay period is proportional to the age and/or swimming ability of a person to be monitored via the monitoring method.

Preferably, the method further comprises detecting the strength of the signal from the first and/or second communications device, and determining when the signals strength drops below a predetermined level, and generating an alert when the signal strength falls below the predetermined level.

In accordance with a third aspect of the present invention, there is provided a monitoring system comprising a first module and a second module, the first module comprising:

sensing means operable to sense the state of an environment in which the first module is located; and

first communications means coupled to the sensing means and operable to transmit a first signal to the second module indicative of the sensed environment and in response to the sensed state of the environment;

the second module comprising:

second communications means operable to receive the first signal from the first module;

alerting means coupled to the second communications means and operable to generate an alert in response to a change in condition of the state of the sensed environment;

variable timing means coupled to the alerting means and operable to delay generation of the alert by the alerting means for a variable predetermined time delay period; and

controlling means operable to set the length of the variable predetermined time delay period in response to user input.

### BRIEF DESCRIPTION OF THE DRAWINGS

The present invention will now be described, by way of example only, with reference to the accompanying drawings, in which:

FIG. 1 is a schematic drawing of the components of a first embodiment of a monitoring system in accordance with an aspect of the present invention;

FIG. 2 is a schematic drawing of the components of a child unit of the monitoring system of FIG. 1;

FIG. 3 is a schematic drawing of the components of a parent unit of the monitoring system of FIG. 1;

FIG. 4 is a side view of the child unit of the monitoring system of FIG. 1 worn by a child;

FIG. 5 is a side view of the monitoring system of FIG. 1 in use;

FIGS. 6a-6f are a sequence of timing diagrams showing the value of a timer of the monitoring system of FIG. 1 over time compared with the value of a timer of an alternative embodiment of a monitoring system in accordance with an aspect of the present invention over time; and

FIG. 7 is a table showing an example of a basic polling protocol used in another embodiment of a monitoring system in accordance with an aspect of the present invention.

### DETAILED DESCRIPTION OF EXAMPLE EMBODIMENTS OF THE INVENTION

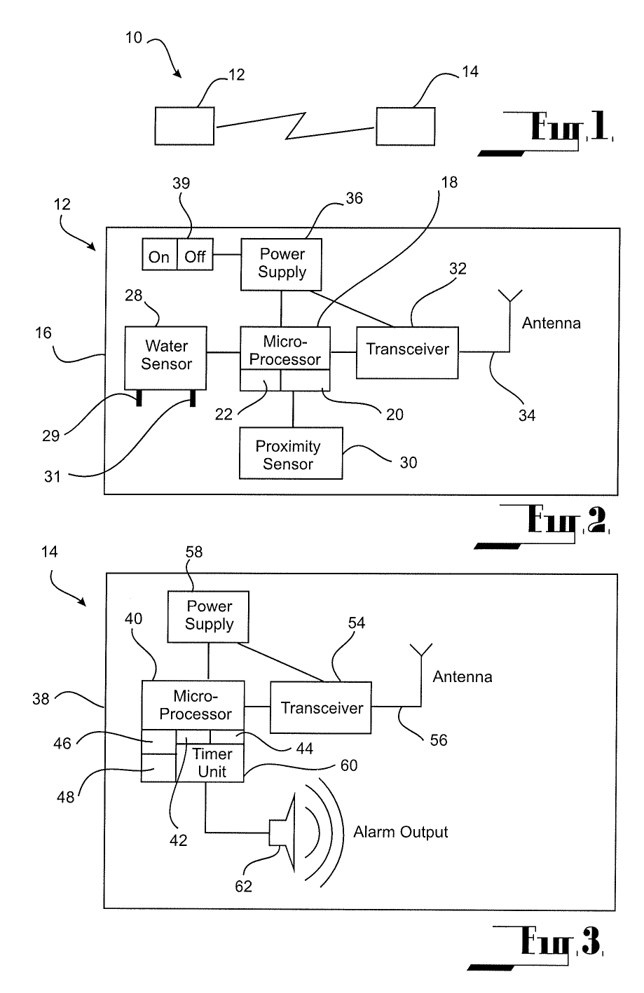

In FIG. 1, there is shown a first embodiment of a monitoring system 10 in accordance with the present invention.

In the embodiment, the system 10 is intended to be used by an adult to monitor or supervise a young child having little or no swimming ability when playing in or near water, such as at a beach or a swimming pool.

The monitoring system and method of the present invention is not limited to such monitoring, however, and in alternative embodiments may be used to monitor any person or animal in a potentially hazardous environment from which they may require rescue or assistance. For example, an elderly or physically/mentally impaired person having a bath, a diver exploring a flooded cave, an emergency worker entering a burning building, or a dog playing in a park, could all be monitored by use of alternative embodiments of the present invention.

The system 10 comprises a portable, first module in the form of a child unit 12 capable of communicating with a portable, second module in the form of a parent unit 14. Both the child unit 12 and the parent unit 14 are small in size for comfort and convenience. In an alternative embodiment of the invention, the parent unit 14 may be a large, stand alone unit, enabling it to be positioned in a central location, such as on a table.

The child unit 12, illustrated in FIG. 2 of the drawings, comprises a child unit casing 16 housing an embedded child unit microcontroller 18 having child unit memory 20 for storing a child unit program and a unique identifier for the child unit 12. Additionally, the child unit microcontroller 18 comprises a child unit processor 22 coupled to the child unit memory 20. The child unit microcontroller 18 is operable to execute application software stored in the child unit memory 20, such as the child unit program. The child unit program is operable to enable the child unit 12 to perform various functions, described in further detail below.

The child unit casing 16 is waterproof to allow the components of the child unit 12 to function when immersed in water. Additionally, the child unit casing 16 is provided with an attachment device in the form of an adjustable strap 24 having hook and loop type fasteners for removable attachment of the child unit 12 to a child 26 to be monitored.

The adjustable strap 24 is provided with a removal preventer in the form of a sliding cover, not shown, that may be positioned over the hook and loop type fasteners when fastened together to prevent them from becoming unfastened—thereby preventing accidental removal of the child unit casing 16 from the child 26 once attached thereto. In this manner, the attachment is made substantially tamper proof.

The child unit 12 has sensors operable to sense the state of an environment in which the child unit 12 is located, and in particular a predetermined hazardous condition in a detection area in the environment. In the embodiment described, the sensors comprise a water sensor 28 operable to sense when the child unit 12 is immersed in water, and a body proximity sensor 30 operable to sense when the child unit 12 has been removed (either accidentally or deliberately) from the child 26.

The water sensor 28 is operatively coupled to the child unit microcontroller 18 to produce and send a water detection signal thereto when it senses that the child unit 12 is immersed in water. The body proximity sensor 30 is similarly operatively coupled to the child unit microcontroller 18 to produce and send a body separation signal thereto when it senses that the child unit 12 has been removed from the child 26. Accordingly, immersion of the child unit 12 in water and separation of the child unit 12 from the child 26 comprise two hazardous states or conditions that may be sensed in the environment.

The water sensor 28 senses that the child unit 12 has been immersed in water by detecting a change in conductivity that occurs when it is immersed.

The water sensor 28 has exposed first and second metal terminals, 29 and 31, respectively. The first terminal 29 is connected to a power supply 36 of the child unit 12, to be discussed in further detail below. The second terminal 31 is connected to a first Analogue-to-Digital Converter (“ADC”) input pin, not shown, of the child unit microcontroller 18. When the child unit 12 is out of the water, no current flows between the first terminal 29 and the second terminal 31. However, when the child unit 12 is immersed in water, the exposed first and second terminals 29 and 31 are similarly immersed, and the conductivity of water allows current to flow from the first terminal 29 to the second terminal 31, thereby creating a water detection voltage at the second terminal 31. The water detection voltage defines the water detection signal.

The child unit microcontroller 18 is operable to sample the voltage at the first ADC input pin at regular, predetermined intervals. If a voltage of sufficient amplitude, i.e. a water detection signal, is detected by the child unit microcontroller 18 at the first ADC input pin, then an indication is provided to the child unit microcontroller 18 that the child unit 12 has been immersed in water.

The body proximity sensor 30 senses that the child unit 12 has been separated from the body of the child 26 by detecting a change in capacitance that occurs when it is so removed. The body proximity sensor 30 has a metal capacitor plate, not shown, with a value of capacitance C. The value of capacitance C varies according to whether the body proximity sensor 30 is in proximity to a human body or not, with the value of capacitance C decreasing when the body proximity sensor 30 is not in close proximity to such a body.

The capacitor plate is coupled to a second ADC input pin, not shown, of the child unit microcontroller 18. When instructed by the child unit microcontroller 18, the body proximity sensor 30 is operable to apply a voltage to the capacitor plate through a resistor, not shown, with a value of resistance R. The child unit microcontroller 18 is operable to then measure a time T_{c} required to charge the capacitor to ⅔ of the applied voltage. The time T_{c} is proportional to the value of the capacitance C according to the formula T_{c}=1.1 RC.

Accordingly, as the value of the capacitance C decreases when the body proximity sensor 30 is not in close proximity to a human body, a sufficiently large decrease in the value of the time T_{c} indicates to the child unit microprocessor 18 separation of the child unit 12 from the body of the child 26. The time T_{c} defines the body separation signal.

In an alternative embodiment of the invention, commercially available touch/proximity sensors are used to sense when the child unit 12 is in contact with the child's 26 body. These commercially available touch/proximity sensors may operate using similar techniques to the capacitive proximity sensor described above, or may use different methods of detecting touch/proximity. The touch/proximity sensor provides a digital output indicative of the value of capacitance between a metal plate of the touch sensor and the child's 26 body. This digital output is coupled to digital input/output (“I/O”) pins of the child unit microcontroller 18. The child unit microcontroller 18 samples the digital I/O pins at regular intervals to determine the value of capacitance. Alternatively, an interrupt may be enabled to interrupt the child unit microcontroller 18 at any time should the value of capacitance fall below a pre-determined limit.

Water sensors and body proximity sensors are well known to persons skilled in the art and, as such, need not be described in any further detail herein, except as is relevant to the present invention.

A first communications device is also provided within the child unit 12, facilitating communication between the child unit 12 and the parent unit 14. The first communications device comprises a child unit transceiver 32 operatively coupled to the child unit microcontroller 18 and a child unit antenna 34 to enable the child unit 12 to transmit message signals to the parent unit 14 indicative of the sensed environment and in response to the sensed state of the environment, and to receive message signals transmitted from the parent unit 14.

The child unit transceiver 32 (and parent unit transceiver 54 discussed in more detail below) both have the ability to measure the received radio signal's quality (Signal Quality Indicator—SQI) and signal strength (Received Signal Strength Indicator —RSSI), and report this to the child unit microcontroller 18 (and parent unit microcontroller 40, as discussed below). These two functions are built into the child unit and parent unit transceivers 32, 54 by the transceiver's manufacturer. A poor signal quality (indicating radio frequency interference) or low signal strength (indicating out-of-radio-range) are third and fourth hazardous conditions that may be sensed in the environment.

The child unit and parent unit transceivers 32, 54 have the ability to perform Direct Sequence Spread Spectrum modulation to increase immunity to interference.

The message signals are radio frequency signals in the 2.4 GHz band.

The use of SQI and RSSI and Direct Sequence Spread Spectrum modulation are known in the art and need not be described in any further detail herein, except as is relevant to the present invention.

In the embodiment described, the child unit antenna 34 is a chip/ceramic antenna, so as to be physically small. Antenna efficiency and gain are important to minimise the output power of the child unit transceiver 32, and hence minimise power consumption and maximise battery life. A small antenna size is also important to minimise the physical size of the child unit 12 to make it as comfortable as possible for a child to wear.

In this regard, power supply to the child unit 12 is provided by an energy source in the form of a child unit battery 36 contained in the child unit casing 16. The child unit battery 36 is a rechargeable battery, and is connected to the electronic components of the child unit 12 to provide power thereto. The child unit 12 also has an on/off switch 39. The child unit 12 being turned off via the on/off switch comprises a fifth hazardous state of the environment that may be sensed.

The child unit battery 36 is coupled to a third ADC input pin, not shown, of the child unit microcontroller 18. The child unit microcontroller 18 is operable to sample the third ADC input pin at regular intervals, and trigger a low child unit battery alert when it senses that the child unit battery 36 needs recharging. Low child unit battery 36 charge comprises a sixth hazardous state of the environment that may be sensed.

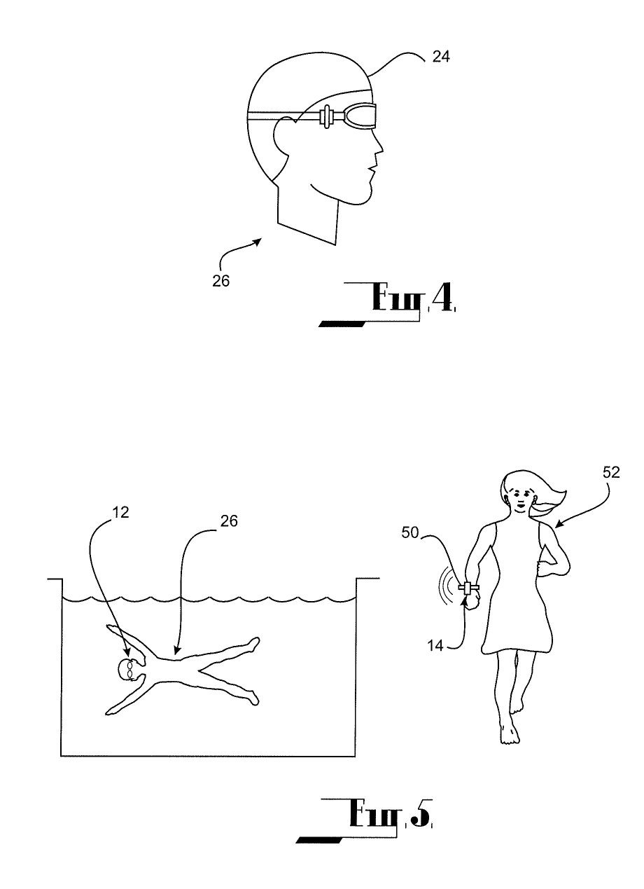

Referring to FIG. 3 of the drawings, the parent unit 14 comprises a parent unit casing 38 for housing the components of the parent unit 14. These components comprise an embedded parent unit microcontroller 40 having parent unit memory 42 for storing a parent unit program and the unique identifier of the child unit 12. The parent unit microcontroller 40 also comprises a parent unit processor 44 coupled to the parent unit memory 42, as well as user interfaces such as a keypad 46 and a display 48. The parent unit microcontroller 40 is operable to execute application software stored in the parent unit memory 42, such as the parent unit program. The parent unit program is operable to enable the parent unit 14 to perform various functions, described in further detail below.

Similarly to the child unit casing 16, the parent unit casing 38 is waterproof to allow the components of the parent unit 14 to function when immersed in water, as may occur during rescue of the child 26. The parent unit casing 38 is provided with an attachment device in the form of an adjustable strap 50 having hook and loop type fasteners for removable attachment of the parent unit 14 to a supervising adult 52.

As in the case of the child unit 12, the adjustable strap 50 of the parent unit casing 38 is provided with a removal preventer in the form of a sliding cover, not shown, that may be positioned over the hook and loop type fasteners when fastened together to prevent them from becoming unfastened. The sliding cover functions to prevent accidental removal of the parent unit casing 38 from the adult 52 once attached thereto, thereby making the attachment substantially tamper proof. The parent unit 14 has a second communications device in the form of a parent unit transceiver 54 operatively coupled to the parent unit microcontroller 40 and a parent unit antenna 56 to enable the parent unit 14 to transmit message signals to the child unit 12, and to receive message signals sent therefrom. The parent unit antenna 56 is also chip/ceramic antenna.

The Physical Layer (“PHY”) and Medium Access Control (“MAC”) layer specifications for the radio communications link between the child unit 12 and the parent unit 14 confirm to the IEEE802.15.4 international standard for Wireless Personal Area Networks (“WPAN”s), although other specifications may also be used.

An energy source in the form of a rechargeable parent unit battery 58 is provided in the parent unit casing 38. The parent unit battery 58 is connected to the electronic components of the parent unit 14 to provide power thereto.

The parent unit battery 58 is coupled to an ADC input pin, not shown, of the parent unit microcontroller 40. The parent unit microcontroller 40 is operable to sample its ADC input pin at regular intervals, and trigger a low parent unit battery alert when it senses that the parent unit battery 58 needs recharging.

The parent unit 14 additionally comprises a timer 60 having variable delay, which is internal to the parent unit microcontroller 40, and an alerting device in the form of an alarm 62. The alarm 62 is operatively coupled to the parent unit microcontroller 40 so that the alarm 62 generates an audible alert in response to a change in condition of the state of the sensed environment after a predetermined time delay period T.

The timer 60 operates to delay the generation of the audible alert by the predetermined time T.

The predetermined time T is not fixed for the timer 60, and may be varied. In this regard, the parent unit microcontroller 40 is operable via the keypad 46 to select and set the length of the predetermined time T the generation of the audible alert is delayed by the timer 60.

Providing a timer having variable delay in the parent unit 14, rather than the child unit 12, is advantageous as it enables the adult 52 to select and set the length of the variable predetermined time delay period, and thereby flexibly control the alert triggering time, according to the freedom to be allowed to the child 26, and the amount of time the child 26 is allowed to be in, or under, the water. This is described in further detail below.

The functions of the above components, and additional features of the system 10, will now be described with reference to the system 10 in use.

To monitor the child 26, the adult 52 firstly attaches the child unit 12 to a portion of the body or clothing of the child 26 by means of the adjustable strap 24, according to the degree of freedom the child 26 is to be allowed.

For example, if the child 26 has no swimming ability, and/or is not to enter the water under any circumstances, then the adult 52 needs to ensure that the child 26 doesn't go in the water. In this case, the child unit 12 should be attached around the ankle or wrist of the child 26, and worn like a watch or bracelet, so that if the child 26 enters the water the child unit 12 will be immersed therein.

Alternatively, if the child has at least some swimming ability, and is allowed in the water, but is not a strong swimmer, then the adult 52 needs to keep a close eye on the child 26 to ensure that he or she doesn't drown. There may be a number of other children splashing and playing in the water, and the child unit 12 may get wet and the child 26 may submerge momentarily, for example as part of a diving game, but should come up for air. Accordingly, in this instance the child unit 12 should be worn as high as possible by the child 26, and preferably near or above their mouth and nose, for example, attached to goggles, headband, hat, hair-elastic, or clothing worn by the child 26. This is illustrated in FIG. 4 of the drawings.

The adult 52 then operates the parent unit microcontroller 18 via the keypad 46 to select and set the predetermined time T the generation of the audible alert is delayed by the timer 60, and activate the system 10. The value of the set predetermined time T is shown on the display 48.

Preferably, the set predetermined time equals the Breath Hold Duration (“BHD”) of the child 26. The BHD is the time that a person is able to hold their breath before the body's physiological reflex to take a breath takes over. If a person has been holding their breath for longer than their BHD, then there is a chance that the person is in need of air, and hence may be in danger of drowning. Accordingly, if the child unit 12 has been submerged for a period of time exceeding the BHD for the child 26, then the head of the child 26 may have also been submerged beneath the water for that period of time, and the child 26 may require assistance.

The BHD for a person is age dependent, and may be calculated using the following formula:
BHD (seconds)=−1.46+2.27A,

where A is the age of the person in years.

Accordingly, for non-swimmers and/or children not allowed in the water, the predetermined time T would be set to a small value—to trigger the alert without any time delay. For younger children and/or weak swimmers, the predetermined time T would be set to a low value—to trigger the alert after a relatively short time delay. For older children and/or reasonably good swimmers, the predetermined time T would be set to a higher value—to trigger the alert after a relatively long time delay.

As well as calculating and setting the predetermined time T according to the above formula or based on their confidence in the swimming ability of the child, the adult 52 may operate the parent unit microcontroller 40 via the keypad 46 to select a mode of operation of the system 10, with each mode having a corresponding value for the predetermined time delay period T. The mode of operation is also shown on the display 48.

In the embodiment described there are five modes of operation, dependent on the age of the child 26, as follows:
1. The child 26 cannot swim and/or is not permitted to enter the water: T=1 second;
2. The child 26 is allowed in the water and is four years old or less: T=8 seconds;
3. The child 26 is allowed in the water and is between five and seven years old: T=16 seconds;
4. The child 26 is allowed in the water and is between seven and eleven years old: T=24 seconds; and
5. An adult needs to be supervised while in the water: T=43 seconds.

Alternative embodiments of the invention may have different modes of operation.

The parent unit 14 may then be attached to a convenient portion of the body or clothing of the adult 52 by means of the adjustable strap 50, such as their wrist or a belt, or otherwise kept near to hand, such as in a pocket or on a nearby table. Although the parent unit casing 38 is waterproof, the supervising adult 52 should not swim whilst using the system 10, to avoid the generation of false alarms.

In the preferred embodiment, the system 10 uses a so-called ‘sleep-then-wake’ method to determine the status of the child unit 12 to determine if a hazardous condition exists. In this method, once the system 10 is activated, the child unit microcontroller 18, under instructions from the child unit program software, generates and sends status information messages at regular one second intervals to the parent unit 14 via the child unit transceiver 32 and the child unit antenna 34. Each status information message contains the unique identifier for the child unit 12, together with information on the status of the body proximity sensor 30, RSSI, SQI, child unit battery 36 levels, and the on/off switch 39 for that child unit 12. In order to conserve battery power, when the child unit 12 is not transmitting, it goes to sleep and wakes up in time to perform status checks and send the next status information message.

During normal operation of the system 10, the parent unit 14 receives the status information message via the parent unit antenna 56 and the parent unit transceiver 54.

If the contents of the status information message shows that none of the above-mentioned hazardous conditions have been met (i.e. the status of the water sensor 28, body proximity sensor 30, Received Signal Strength Indicator (“RSSI”), Signal Quality Indicator (“SQI”), child unit battery 36 level, and on/off switch 39 are all normal), then the parent unit 14 takes no action other than to update the display 48 with the new status information.

If the contents of the status information message shows that the child unit's battery level 36 is low, then the parent unit microcontroller 40 operates to show a low child unit battery warning symbol on the display 48, and bypasses the timer 60 to activate the alarm 62 to generate the audible alert without any time delay, thereby indicating to the adult 52 that the child unit battery 36 needs to be recharged or replaced. The adult 52 can then investigate and take appropriate action.

Similarly, if a low parent unit battery alert is triggered, the parent unit microcontroller 40 operates to show a low parent unit battery warning symbol on the display 48, and bypasses the timer 60 to activate the alarm 62 to generate the audible alert without any time delay—indicating that the parent unit battery 58 needs recharging or replacing.

If the contents of the status information message shows that the child unit 12 has been separated from the child's 26 body, then the parent unit microcontroller 40 operates to show a body separation warning symbol on the display 48, and bypasses the timer 60 to activate the alarm 60 to generate the audible alert without any time delay, thereby indicating to the adult 52 that the child unit 12 has been removed from the body of the child 26.

Alternatively, if the child unit 12 gets separated from the child's 26 body, the child unit 12 is operable to sense this via the body proximity sensor 30, wake up immediately (i.e. without waiting for the send of the one second sleep time) and send the status information message to the parent unit 14. In this way, should the child unit 12 fall off the child 26 while in water, the child 12 unit will have been able to send this message before it hits the water.

If the contents of the status information message indicates that the signal level received by the child unit 12 is low (i.e. the RSSI is lower than a pre-determined threshold for x out of the last y status information messages), then the parent unit microcontroller 40 operates to show an out-of-range warning symbol on the display 48, and bypasses the timer 60 to activate the alarm 60 to generate the audible alert without any time delay, thereby indicating to the adult that the child has wandered too far away.

The RSSI threshold is set at a level such that there is sufficient signal strength to allow reliable communication between the child unit 12 and the parent unit 14 to continue, so that the adult 52 has the ability to page the child 26 via the system 10 to tell him to come closer. This also allows the system 10 to distinguish between an out-of range alarm condition (i.e. the signal level is low, but not low enough to lose communications) and a water immersion alarm condition (i.e. the radio signal has been completely lost).

If the contents of the status information message indicates that the level of interference of the radio link is high (i.e. the SQI is higher than a pre-determined threshold for x out of the last y status information messages), then the parent unit 14 will operate to coordinate with the child unit 12 to change frequency channel. If this channel change is attempted a pre-determined number of times without successfully finding an interference-free channel, then the parent unit microcontroller 40 operates to show an interference warning symbol on the display 48, and bypasses the timer 60 to activate the alarm to generate the audible alert without any time delay. The parent unit 14 is also operable to perform RSSI and SQI monitoring for its own end of the radio link, and can trigger an out-of-range alarm, frequency channel changes, and interference alarms based on this information in a corresponding manner.

If the contents of the status information message indicates that the on/off switch 39 on the child unit 12 has been pressed in order to turn the child unit 12 off, then the parent unit 14 is operable to inform the adult 52 of this action (via a deactivation warning symbol on the display 48 and an audible alert), and ask the adult 52 to confirm that the child unit 12 is to be turned off. Upon receiving an affirmative input from the adult, via the keyboard 46, the parent unit 14 operates to send an affirmative response message to the child unit 12 indicating that it is acceptable to turn off. The child unit 12 will continue to operate normally until it receives the affirmative response message from the parent unit 14. In this way, unauthorised deactivation of the child unit 12 is avoided.

An alternative to the sleep-then-wake method outlined above is a polling method, an embodiment of which is described below.

The polling method is similar to the sleep-then-wake method except that the child unit 12 stays awake all the time, and the parent unit microcontroller 40 generates and sends polling messages at regular, one second intervals to the child unit 12 via the parent unit transceiver 54 and parent unit antenna 56. Each polling message comprises the unique identifier for the child unit 12, and a request from the child unit 12 to respond with a status information message. In this way, the parent unit 14 controls when the child unit 12 sends its status information message, rather than having the messages arriving when the child unit 12 wakes up.

A disadvantage of this polling method is that the battery power consumption in the child unit 12 is considerably higher than the sleep-then-wake method, because the child unit 12 needs to stay awake (in receive mode) all the time, which consumes a lot more power than when it is in sleep mode.

An advantage of the polling method is that, in an embodiment of the invention where a plurality of child units 12 are monitored by a single parent unit 14, when each child unit 12 is awake, they can monitor the signal strength from other child units 12, allowing the system 10 to indicate the approximate location of the child unit 12 (as will be discussed in further detail below in relation to the “locator unit” discussion at the end of the specification).

Continuing the description of the first embodiment, if the child unit microcontroller 18 receives a water detection signal from the water sensor 28, then the child unit microcontroller 18 is instructed by the child unit program software to cease sending status information messages.

This action continues until it ceases to receive the water detection signal, indicating that the child unit 12 is no longer immersed in water. At that time the child unit microcontroller 18 is instructed by the child unit program software, to re-commence generating and sending status information messages.

Such disabling of communications provides a fail safe technique that allows the system 10 to work well in all water types, and to generate an alert should the child unit 12 fail in any way, and the environment therefore become hazardous. Some prior art monitoring systems work by activating a transmitter upon immersion in water, but due to the fact that radio signals are significantly attenuated in salty water (or water with a high mineral content), these systems do not work well in such waters. In addition, if there is a failure in the monitored unit of such a system, the monitoring unit is not notified of the failure. The fail safe monitoring system of the present invention therefore provides an advantage over such prior art systems.

A non-response from the child unit 12 communicates to the parent unit 14 that a predetermined hazardous condition has been sensed in the detection area and the environment has changed to a hazardous state—namely that the child unit 12 is submerged in water. A non-response from the child unit 12 could also indicate that: the child unit battery 36 has gone flat; the child unit 12 is out of radio range; the radio link is suffering from interference; or the child unit 12 has been turned off. However, the low-battery warning alarm, the out-of-range warning alarm, and/or the interference warning alarm should have sounded prior to failure, and the parent unit 14 will have given permission for the child unit 12 to turn off. Therefore, any non-response from the child unit 12 without any prior alarm should be due solely to immersion of the child unit 12 in water.

If the parent unit 14 does not receive a status information message from the child unit 12 within a predetermined period of time, then the timer 60 begins counting down the predetermined time delay period T.

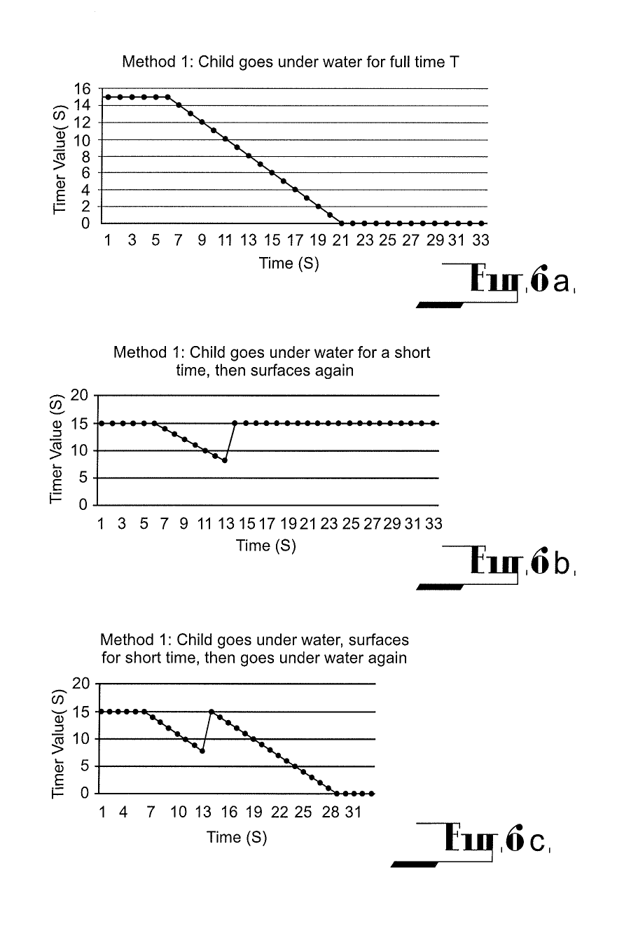

If the predetermined time T expires before the parent unit 14 receives a status information message from the child unit 12, then the alarm 62 will generate the audible alert, and the parent unit microcontroller 40 operates to show an emergency symbol on the display 48. In this manner the adult 52 is provided with a visual and aural indication that a hazardous condition has occurred, and emergency action may need to be taken. The adult 52 can then investigate and take action as appropriate, as illustrated in FIG. 5 of the drawings.

If the parent unit 14 receives a status information message from the child unit 12 before expiry of the predetermined time T, then the count down is aborted, the value of the timer 60 is reset to the full amount of the predetermined time T and the system 10 returns to normal operation as described above. In this manner, an alert will not be generated if the child 26 has, for example, dived beneath the water and resurfaced before expiry of the predetermined time, or the child unit 12 has been splashed with water.

In an alternative embodiment of the present invention, rather than being reset to the full amount of the predetermined time T on receipt of the first status information message following a period of no response, the value of the timer 60 is gradually increased in predetermined increments back to the full amount of predetermined time T with each successive status information message received by the parent unit 14. This is advantageous in cases where a distressed or fatiguing swimmer momentarily surfaces for a breath of air, only to submerge again without sufficient time to take a deep breath of air, and hence is in danger of drowning within a shorter period of time than the full value of the predetermined time delay period T.

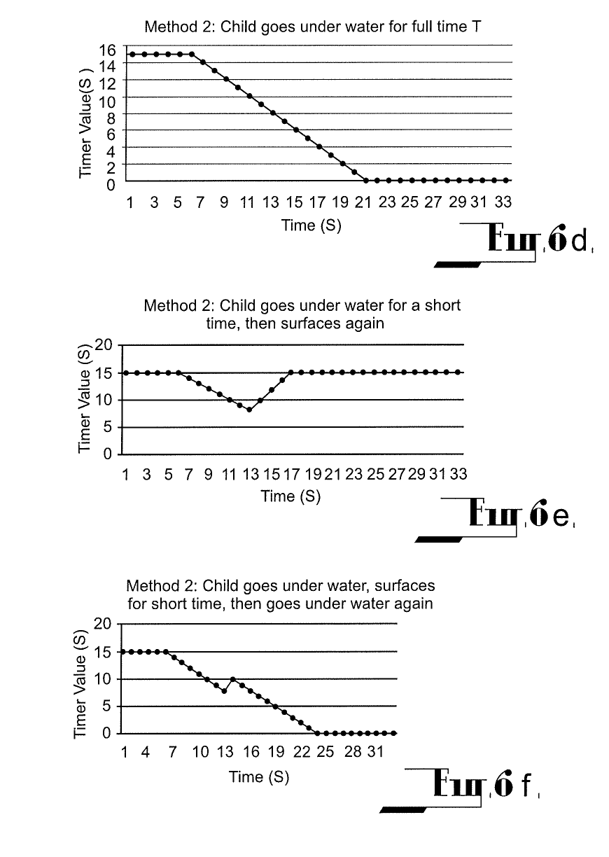

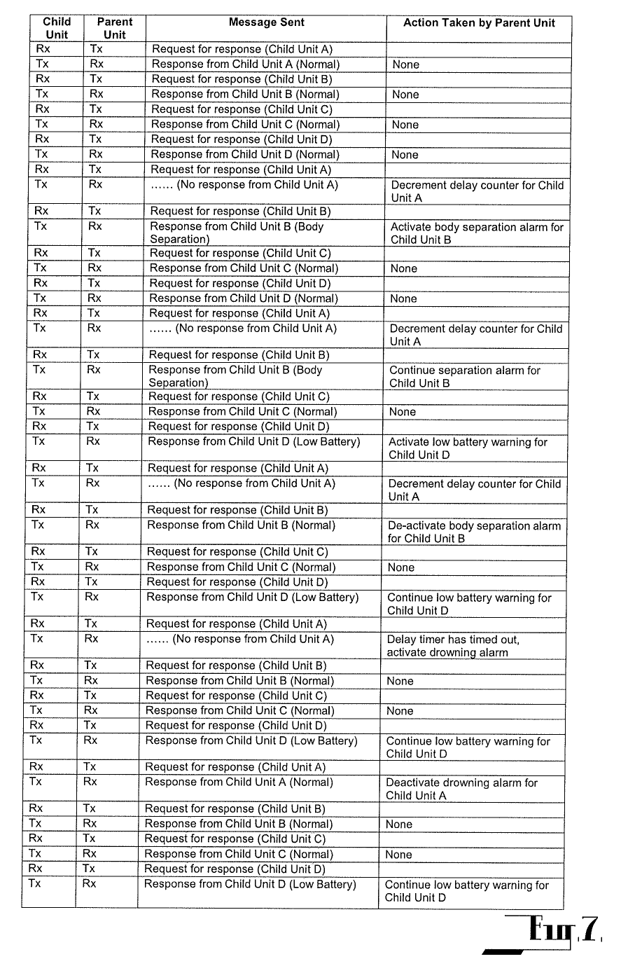

FIGS. 6a-6f of the drawings illustrate this alternative method for controlling the value of the timer 60, compared with the method of the first embodiment.

In a further alternative embodiment of the present invention, rather than being reset to the full amount of the predetermined time T on receipt of the first status information message following a period of no response, the value of the timer 60 is set to a shorter predetermined time delay period Tₛ, less than the predetermined time delay period T. In this instance, the value of the timer 60 may then be gradually increased back to the full amount of predetermined time T with each successive status information message received by the parent unit 14.

In another alternative embodiment of the present invention, the system 10 may be used to monitor the water level in a body of water, such as a dam or a river, and generate an alert when the water level exceeds a critical level. In this case, the child unit 12 may be installed at the critical level, so that when the water rises to the critical level it is sensed by the water sensor 28 and a water detection signal generated. False alarms, which may be triggered by waves intermittently splashing the child unit 12, may be avoided by setting the predetermined time delay period T suitably large so that the child unit 12 must be submerged for an extended period of time before the alert is generated.

A second embodiment of the invention is directed toward a modification of the system 10 of the first embodiment. Corresponding numerals are used to denote like elements of the first and second embodiments.

The system 10 of the second embodiment, useful in cases where the adult 52 needs to supervise a number of children, differs from the first embodiment in the following respects.

In the second embodiment of the system 10 there is provided a plurality of child units 12, each having a unique identifier. The parent unit memory 42 stores the unique identifier of each of the child units 12 in the plurality of child units 12.

Each child unit 12 of the plurality of child units 12 can be set with a different predetermined time delay period T or mode, as described previously. The predetermined time T or mode of operation for each child unit 12 is shown on the display 48 of the parent unit 14.

As in the first embodiment, a ‘sleep-then-wake’ status monitoring method is used. Once the system 10 is activated, each child unit microcontroller 18 generates and sends status information messages at regular one second intervals to the parent unit 14 via the child unit transceiver 32 and the child unit antenna 34. Carrier Sense Multiple Access with Collision Avoidance (“CSMA/CA”) capability of the system 10 ensures that the child units 12 are able to transmit without interfering with other child units 12 that are trying to transmit at the same time. Each status information message contains the unique identifier for the child unit 12, together with information on the status of the body proximity sensor 30, RSSI, SQI, child unit battery 36 levels, and on/off switch 39 for that child unit 12. In order to conserve battery power, when the child unit 12 is not transmitting, it goes to sleep and wakes up again in time to perform status checks and send the next status information message.

During normal operation of the system 10, the parent unit 14 receives the status information messages via the parent unit antenna 56 and the parent unit transceiver 54.

If the contents of each status information message shows that none of the above-mentioned hazardous conditions have been met (i.e. the status of the water sensor 28, body proximity sensor 30, Received Signal Strength Indicator (“RSSI”), Signal Quality Indicator (“SQI”), child unit battery 36 level, and on/off switch 39 are all normal for all child units 12), then the parent unit 14 takes no action other than to update the display 48 with the new status information for each child unit 12.

If the contents of a status information message for one or more child unit 12 shows that the child unit battery 36 level is low, then the parent unit microcontroller 40 operates to show a low child unit battery warning symbol for that child unit 12 on the display 48, and bypasses the timer 60 to activate the alarm 60 to generate the audible alert without any time delay, thereby indicating to the adult 52 that the child unit battery 36 needs to be recharged or replaced. The adult 52 can then investigate and take appropriate action.

Similarly, if a low parent unit battery alert is triggered, the parent unit microcontroller 40 operates to show a low parent unit battery warning symbol on the display 48, and bypasses the timer 60 to activate the alarm 62 to generate the audible alert without any time delay—indicating that the parent unit battery 58 needs recharging or replacing.

If the contents of a status information message for one or more child unit 12 shows that the child unit 12 has been separated from the child's body, then the parent unit microcontroller 40 operates to show a body separation warning for that child unit 12 on the display 48, and bypasses the timer 60 to activate the alarm 62 to generate the audible alert without any time delay, thereby indicating to the adult 52 that the child unit 12 has been removed from the body of the child 26.

If the contents of a status information message for one or more child unit 12 indicates that the signal level received by the child unit 12 is low (i.e. the RSSI is lower than a pre-determined threshold for x out of the last y status information messages), then the parent unit microcontroller 40 operates to show an out-of-range warning symbol for that child unit 12 on the display 48, and bypasses the timer 60 to activate the alarm 62 to generate the audible alert without any time delay, thereby indicating to the adult 52 that the child 26 has wandered too far away.

The RSSI threshold is set at a level such that there is sufficient signal strength to allow reliable communication between the child unit 12 and the parent unit 14 to continue. This allows the system 10 to distinguish between an out-of range alarm condition (i.e. the signal level is low, but not low enough to lose communications) and a water immersion alarm condition (i.e. the radio signal has been completely lost).

If the contents of a status information message for one or more child unit 12 indicates that the level of interference of the radio link is high (i.e. the SQI is higher than a pre-determined threshold for x out of the last y status information messages), and the majority of child units 12 are suffering from this problem, then the parent unit 14 will operate to coordinate with the child units 12 to change frequency channel. If this channel change is attempted a pre-determined number of times without successfully finding an interference-free channel, then the parent unit microcontroller 40 operates to show an interference warning symbol on the display 48, and bypasses the timer 60 to activate the alarm 62 to generate the audible alert without any time delay.

The parent unit 14 is also operable to perform RSSI and SQI monitoring for its own end of the radio link, and can trigger an out-of-range alarm, frequency channel changes, and interference alarms based on this information in a corresponding manner.

If the contents of a status information message from a child unit 12 indicates that the on/off switch 39 on the child unit 12 has been pressed in order to turn that child unit 12 off, then the parent unit 14 will operate to inform the adult 52 of this action (via a deactivation warning symbol on the display 48 and an audible alert), and ask the adult 52 to confirm that the child unit 12 is to be turned off. Upon receiving an affirmative input from the adult 52 via the keyboard 46, the parent unit 14 operates to send an affirmative response message to the child unit 12 indicating that it acceptable to turn the child unit 12 off. The child unit 12 will continue to operate normally until it receives the affirmative response message from the parent unit 14. In this way, unauthorised deactivation of the child units 12 is avoided.

If the parent unit 14 does not receive a status information message from the child unit 12, then the system 10 operates as described above in relation to the first embodiment, with the exception that the emergency symbol shown on the display 48 comprises an identification of the particular child unit 12 that did not respond.

Again, a polling method is an alternative to the sleep-then-wake method, but this has an impact on the battery life of the child units 12. A further polling method, differing to that described previously, will now be described. Either polling method may be used in further embodiments of the invention.

If the further polling method is used, then once the system 10 is activated, the parent unit microcontroller 40 generates and sends polling messages to each of the child units 12 in the plurality of child units 12 in turn at regular, one second intervals. Each polling message comprises the unique identifier for the particular child unit 12 of the plurality of child units 12 whose turn it is to be polled, and a request from the particular child unit 12 addressed to respond.

In this embodiment, during normal operation of the system, each child unit 12 of the plurality of child units 12 will generate and send a normal function reply message to the parent unit 14 in response to receiving a polling message containing its unique identifier. Each reply message comprises the unique identifier for the particular child unit 12 addressed, and an indication from that child unit 12 that no action is required to be taken in respect of it.

Provided that a normal function reply message is received by the parent unit 14 from the particular child unit 14 addressed for each polling message sent, the parent unit 14 takes no action other than to continue to transmit polling messages to the plurality of child units 12 in turn.

If a low child unit battery alert is triggered in a particular child unit 12, then it generates and sends a low child unit battery reply message containing its unique identifier to the parent unit 14 in response to each polling message received addressed to it, until its child unit battery 36 is recharged, or goes flat.

On receipt of such a low child unit battery reply message, the parent microcontroller 40 operates to show the low child unit battery warning symbol on the display 48 together with an identification of the particular child unit 12 that sent the low child unit battery reply message. Additionally, it bypasses the timer 60 to activate the alarm 62 to generate the audible alert without any time delay.

If the child unit microcontroller 18 of a particular child unit 12 receives a body separation signal from its body proximity sensor 30, then the child unit microcontroller 18 generates and sends a body separation reply message containing the unique identifier of the particular child unit 12 to the parent unit 14 in response to each polling message received addressed to it until the child unit 12 is re-attached to the body of the child 26.

On receipt of such a body separation reply message, the parent unit microcontroller 40 operates to show the body separation warning symbol on the display 48 together with an identification of the particular child unit 12 that sent the body separation reply message. It also bypasses the timer 60 to activate the alarm 62 to generate the audible alert without any time delay, indicating that the particular child unit 12 has been removed from the body of the child 26 to which it had been attached.

If the parent unit 14 does not receive a response to a polling message from the child unit 12 which was addressed, then the system 10 operates as described above in relation to the first embodiment, with the exception that the emergency symbol shown on the display 48 comprises an identification of the particular child unit 12 that did not respond.

The table illustrated in FIG. 7 of the drawings provides an example of the basic polling protocol used in the system 10 of the second embodiment of the invention with four child units 12, designated by unique identifiers Child Unit A, Child Unit B, Child Unit C and Child Unit D, respectively, being monitored by a single parent unit 14. In this example, Child Unit A is immersed in water for a period of time exceeding the predetermined time T so that the alarm 62 generates the audible alert as described previously; Child Unit B is separated from the child's body for a short period of time, less than the predetermined time T; Child Unit C functions normally; and Child Unit D develops a low child unit battery 36. Child Unit A, Child Unit B, Child Unit C and Child Unit D all use the same frequency.

In all other respects, the system 10 of the second embodiment is substantially the same as in the first embodiment, and shall not be described in further detail.

Several advantages arise from the sleep-then-wake method, of the first and second embodiments, in which each child unit 12 stays awake for only a fraction of the time (as opposed to a 100% duty cycle), including:
it reduces the possibility of interference with other devices in the vicinity that may be transmitting on the same frequency channel;
it allows more devices to share the same set of frequency channels;
it maximises the life of the child unit battery 36; and
it allows multiple child units 12 to be monitored by a single parent unit 14.

It should be appreciated by the person skilled in the art that the invention is not limited to the embodiments described. For example, the invention as described can include the following modifications and/or additions:
the child unit microcontroller 18 and the parent unit microcontroller 40 are not limited to being embedded microcontrollers and may comprise any computing or controlling means;
there may be only one sensor, and the water sensor 28 and/or the body proximity sensor 30 may be replaced with other sensor(s) relevant to the environment in which the person or animal is being monitored, such as heart rate sensors, pressure sensors (to detect whether they are sinking), motion sensors, gas sensors, infrared sensors, and light sensors;
the second communications device of the parent unit 14 may be further operable to communicate with an existing alarm system located in a structure remote from the environment in which the person or animal is being monitored. The structure may be a house. In this case the second communications device may generate and send an activation signal to activate the existing alarm system to generate an alert on expiry of the predetermined time delay period T;
antennas other than chip/ceramic antennas may be used, including loop/semi-loop printed circuit board antennas, and other small antenna types. Additionally the child unit antenna 34 and/or the child unit 12 may be incorporated into an article of clothing, such as a headband;
the RSSI threshold may be set by the adult for each child unit 12, via the parent unit 14, to control how far each child 26 is allowed to wander away from the parent unit 14 before the out-of-range alarm is triggered;
rather than being portable, the parent unit 14 may be fixed to a structure in the environment in which the person or animal is being monitored, such as a pool fence;
rather than being carried by the parent, the parent unit 14 may be a portable stand-alone unit designed to sit on a table in a central location;
the parent unit 14 may also be “docked” into a standalone unit to allow the parent to swim while the parent unit 14 continues to monitor the child units 12. The docking station would have a louder audible alarm, plus a larger and brighter visual alarm, than the parent unit itself to allow the alarm to be noticed from further away. The docking station may also be used for re-charging the parent unit 14 and child units 12;
frequency bands other than 2.4 GHz may be used, such as, for example, 433 MHz, 915 MHz, and 5.8 GHz;
furthermore, the system 10 may use frequency hopping techniques to reduce radio interference from other radio frequency devices transmitting on the same frequency;
communications techniques other than the polling method and the sleep-then-wake with CSMA/CA method, described may be used to facilitate communications between the child unit 12 and the parent unit 14. For example, the parent unit 14 may communicate with only one dedicated child unit 12, in which case a plurality of parent units 14, each with a dedicated child unit 12, would be required to monitor a plurality of children. The plurality of parent units 14 may be incorporated into a single housing holding multiple parent units 14;
a tactile alert, such as a vibration, may be generated In addition, or as an alternative, to generating a visual and/or audible or aural alert;
the child unit 12 may be provided with an alerting device to generate an alert to assist the adult 52 in locating the child 26 when the alert is generated;
attachment devices other than adjustable straps having hook and loop type fasteners may be used, including bands, clips, ties, buttons, and buckles;
solar cells may be included in the power supply of the child unit 12 and/or the parent unit 14 to boost battery charge during use, thereby prolonging life of the child unit battery 36 and/or the parent unit battery 58;
rather than having communications between the child unit 12 and the parent unit 14 disabled when the sensor senses a predetermined hazardous condition in the detection area, communications may be enabled when such an event occurs and an alerting signal produced and sent from the child unit 12 to the parent unit 14, with communications disabled otherwise;
the child unit 12 may be provided with a panic button, to be operated by the child 26 when requiring assistance. In this case, the panic button may be operatively coupled to the child unit microcontroller 18 to produce and send a panic signal thereto when pressed. If the child unit microcontroller 18 receives a panic signal, then the child unit computer generates and sends a panic message to the parent unit 14. On receipt of the panic message, the parent microcontroller 40 operates to show a panic symbol on the display 48, and bypasses the timer 60 to activate the alarm 62 to generate the audible alert without any time delay;
the child unit 12 and the parent unit 14 may be provided with a voice communicator operable to enable voice communication between the child 26 and the adult 52 via the system 10. This would facilitate, for example, the adult 52 telling the child 26 to get out of the water, or the child 26 requesting assistance from the adult 52;
the parent unit 14 may be given the means to alert the child unit 12 so that the parent 52 can gain the attention of the child (to tell the child to get out of the water, for example). In such a case, the adult 52 would select which child 26 to send the alert to, and the parent unit 14 would send the alert message to child unit 12 worn by that child 26. The child unit 12 would then flash/vibrate/beep, etc, to alert the child 26;
“Locator Units” could be used to allow the system 10 to determine the approximate location of each child unit 12, so that the adult 52 can be given an indication of the location of each child unit 12. Locator units could take the form of additional child units 12 placed at known locations in the area that the children are swimming, or they may be integrated into the child units 12 and parent unit 14. Each locator unit would measure the signal strength that it receives from each child unit 12, and send that information back to the parent unit 14. The parent unit 14 would then use this information to provide an indication on its display 48 to show approximately where each child unit 12 is located relative to each locator unit. For example, the system 10 may have three locator units “A” (positioned near a shallow-end of a pool), “B” (positioned near a middle of the pool), and “C” (positioned near a deep end of the pool). If the signal strength that these units receive from the child unit 12 is strongest for locator unit “C”, for example, an indication will be provided that the child unit 12 is closer to locator unit “C” than it is to the other locator units. Should a water immersion alarm be triggered, then the parent unit 14 can tell the adult 52 that the last known approximate location of the child unit 12 was nearest to locator unit C (i.e. the deep end of the pool) via the display 48.

It should be further appreciated by the person skilled in the art that variations and combinations of features described above, not being alternatives or substitutes, can be combined to form yet further embodiments falling within the intended scope of the invention.

What is claimed is:

1. A monitoring system comprising a first module and a second module, the first module comprising:
a sensor operable to sense the state of an environment in which the first module is located; and
a first communications device coupled to the sensor and operable to transmit a first signal to the second module indicative of the sensed environment and in response to the sensed state of the environment;
the second module comprising:
a second communications device operable to receive the first signal from the first module;
an alerting device coupled to the second communications device and operable to generate an alert in response to a change in condition of the state of the sensed environment;
a variable timer coupled to the alerting device and operable to delay generation of the alert by the alerting device for a variable predetermined time delay period; and
a controller operable to set the length of the variable predetermined time delay period in response to user input.

2. A monitoring system according to claim 1, wherein the first signal from the first module is indicative of a non-hazardous state of the environment, and a change to a hazardous state of the environment is indicated by the non-receipt of the first signal by the second communications device and the generation of an alert by the alerting device is in response to the non-receipt of the first signal from the first module.

3. A monitoring system according to claim 1, wherein the first signal from the first module is indicative of a hazardous state of the environment, and a change to a hazardous state of the environment is indicated by the receipt of the first signal by the second communications device and the generation of an alert by the alerting device is in response to the receipt of the first signal from the first module.

4. A monitoring system according to claim 1, wherein the timer is operable, in response to a detected change of the environment to a hazardous state, to count down the set variable predetermined time delay period and, upon expiration of the count down, the alerting device is operable to generate the alert.

5. A monitoring system according to claim 1, wherein the first communications device is operable, in response to a detected change of the environment from a hazardous state to a non-hazardous state, to transmit a second signal to the second module, the second communications device is operable to receive the second signal from the first module, and the timer is operable, in response to receipt of the second signal, to abort the delay and reset to the set variable predetermined time delay period, and upon abortion of the delay, the alerting device is operable to not generate the alert.

6. A monitoring system according to claim 1, wherein the timer is operable, in response to a detected change of the environment to a hazardous state, to count down the set variable predetermined time delay period and, wherein the first communications device is operable, in response to a detected change of the environment from a hazardous state to a non-hazardous state, to transmit a second signal to the second module, the second communications device being operable to receive the second signal from the first module, and the timer being operable, in response to receipt of the second signal, to abort the delay and reset to the set variable predetermined time delay period, and upon abortion of the delay, the alerting device is operable to not generate the alert.

7. A monitoring system according to claim 6, wherein the timer is further operable, in response to receipt of the second signal, to abort the count down and reset to the set variable predetermined time delay period, and upon abortion of the count down, the alerting device is operable to not generate the alert.

8. A monitoring system according to claim 5, wherein the timer is operable, in response to receipt of the second signal, to abort the delay and to reset to a shortened predetermined time delay period, less than the set variable predetermined time delay period.

9. A monitoring system according to claim 6, wherein the timer is operable to count down the set variable predetermined time delay period, the timer is further operable, in response to receipt of the second signal, to abort the count down, and start counting up in predetermined increments until the value of the set variable predetermined time delay period is reached.

10. A monitoring system according to claim 8, wherein the timer is further operable, in response to a change in the environment to a hazardous state being detected before the timer has counted up to the value of the set variable predetermined time delay period, to shorten the delay to less than the set variable predetermined time delay period.

11. A monitoring system according to claim 1, wherein the length of the set variable predetermined time delay period is proportional to the age and/or swimming ability of a person to be monitored via the monitoring system.

12. A monitoring system according to claim 1, wherein the first communications device and/or the second communications device comprise a transceiver and an antenna for wireless communication therebetween.

13. A monitoring system according to claim 12, wherein the second and/or first communications device comprises a signal strength detector for detecting the strength of the signal from the first and/or second communications device respectively, and is operable to determine when the signal strength drops below a predetermined level, the alerting device being further operable, in response to a determined signal strength below the predetermined level, to generate an alert.

14. A monitoring system according to claim 1, wherein the sensor comprises at least one of the following set: water sensor; body proximity sensor; heart rate sensor; pressure sensor; motion sensor; gas sensor; infrared sensor; and light sensor.

15. A monitoring system according to claim 1, wherein the first module and/or the second module are waterproof.

16. A monitoring system according to claim 1, wherein the first module and/or the second module are provided with an attachment device for removable attachment to a person.

17. A monitoring system according to claim 16, wherein the attachment device is provided with a removal preventer to prevent accidental removal of the first module and/or the second module from a person.

18. A monitoring method comprising:
sensing the state of an environment;
transmitting a first signal indicative of the sensed environment in response to the sensed state of the environment;
receiving the first signal;
generating an alert in response to a change in condition of the state of the sensed environment; and
delaying generation of the alert for a variable predetermined time delay period, the length of the variable predetermined time delay being set by a user to define a set variable predetermined time delay.

19. A monitoring method according to claim 18, wherein the first signal is indicative of a non-hazardous state of the environment, and a change to a hazardous state of the environment is indicated by the non-receipt of the first signal and the generation of the alert is in response to the non-receipt of the first signal.

20. A monitoring method according to claim 18, wherein the first signal is indicative of a hazardous state of the environment, and a change to a hazardous state of the environment is indicated by the receipt of the first signal and the generation of the alert is in response to the receipt of the first signal.

21. A monitoring method according to claim 18, further comprising counting down the set variable predetermined time delay period in response to a detected change of the environment to a hazardous state, and upon expiration of the count down, generating the alert.

22. A monitoring method according to claim 18, further comprising transmitting a second signal in response to a detected change of the environment from a hazardous state to a non-hazardous state, receiving the second signal, and, in response to receiving the second signal, aborting the delay, resetting the set variable predetermined time delay period, and not generating the alert.

23. A monitoring method according to claim 18, further comprising counting down the set variable predetermined time delay period in response to a detected change of the environment to a hazardous state; and transmitting a second signal in response to a detected change of the environment from a hazardous state to a non-hazardous state, receiving the second signal, and, in response to receiving the second signal, aborting the delay, resetting the set variable predetermined time delay period, and not generating the alert.

24. A monitoring method according to claim 23, further comprising aborting the count down, resetting the set variable predetermined time delay period, and not generating the alert in response to receiving the second signal.

25. A monitoring method according to claim 23, further comprising resetting the delay to a shortened predetermined time delay period, less than the set variable predetermined time delay period, in response to receiving the second signal.

26. A monitoring method according to claim 23, further comprising counting up in predetermined increments, in response to receiving the second signal, until either the value of the set variable predetermined time delay period is reached, or there is a detected change in the environment to a hazardous state.

27. A monitoring method according to claim 18, wherein the set variable predetermined time delay period is proportional to the age and/or swimming ability of a person to be monitored via the monitoring method.

28. A monitoring method according to claim 18, further comprising detecting the strength of the signal from the first and/or second communications device, and determining when the signals strength drops below a predetermined level, and generating an alert when the signal strength falls below the predetermined level.

29. A monitoring system comprising a first module and a second module, the first module comprising:
sensing means operable to sense the state of an environment in which the first module is located; and
first communications means coupled to the sensing means and operable to transmit a first signal to the second module indicative of the sensed environment and in response to the sensed state of the environment;
the second module comprising:
second communications means operable to receive the first signal from the first module;
alerting means coupled to the second communications means and operable to generate an alert in response to a change in condition of the state of the sensed environment;
variable timing means coupled to the alerting means and operable to delay generation of the alert by the alerting means for a predetermined time delay period; and
control means operable to set the length of the variable predetermined time delay period in response to user input.
